(19) United States
(12) Patent Application Publication
(10) Pub. No.: US 2015/0158715 A1
(43) Pub. Date: Jun. 11, 2015

(54) DISPENSER AND COMPOSITION TO MAKE ICE COFFEE

(71) Applicants: Peter KERSTENS, Kapellen (BE); Rudiger Cruysberghs, Brussels (BE)

(72) Inventors: Peter KERSTENS, Kapellen (BE); Rudiger Cruysberghs, Brussels (BE)

(21) Appl. No.: 14/625,310

(22) Filed: Feb. 18, 2015

Related U.S. Application Data
(63) Continuation-in-part of application No. 14/320,901, filed on Jul. 1, 2014.
Application No. 14/320,901 is a continuation of application No. 12/381,697, filed on Mar. 16, 2009, now Pat. No. 8,800,434.

(51) Int. Cl. B67D 7/78; B67D 7/80; A23F 5/24

(52) U.S. Cl. CPC B67D 7/78; A23F 5/243; B67D 7/80

(57) ABSTRACT

The invention encompasses a holder to dispense and prepare ice coffee, consisting of a first compartment containing liquid coffee extract, a second compartment containing a propellant, a nozzle with a valve, and whereby at least one additive, such as sugars, sweeteners, aromas or a combination thereof, can be added to the concentrate in order to spray a jet of product onto a liquid.

This application is a continuation-in-part of U.S. application Ser. No. 12/381,697, which was filed on Mar. 16, 2009 and issued as U.S. Pat. No. 8,800,434 on Aug. 12, 2014.

### FIELD OF THE INVENTION

The present invention encompasses a composition and method of preparation of ice coffee and, in particular, a holder and pressurized dispenser containing an amount of liquid coffee extract to prepare ice coffee, whereby the liquid coffee extract with additives is composed in such a manner that no additional mixing is required.

### BACKGROUND OF THE INVENTION

Ice coffee is a refreshing beverage, consisting of a coffee extract mixed with flavoring which is added to a liquid, such as milk, and ice.

Ice coffee is traditionally prepared by mixing the various ingredients with a blender, whereby it is also possible to crush the ice at the same time.

Such a method is well-known in accordance with JP63301744.

Prepared ice coffee is sold in a recipient such as Nestle's Nescafé frappe®,

For some consumers the solution must he mixed belter, BP1020121 therefore describes a powder which is better solvable in cold milk.

CA951567 and GR1004081 also describe granulates and crystals, respectively, which must be dissolved in order to prepare ice coffee.

Another method to prepare ice coffee is well-known from EP1098570, according to which a cooled coffee is obtained by putting a coffee extract in a liquid under low-oxygen conditions, and adding sodium carbonate as a buffer, sugar and honey. When opening the recipient, the extracted liquid is spread over the crushed ice.

JP2002095416 describes a method to prepare ice coffee in a transparent bottle, consisting of a coffee extract and a milk constituent phase, including an UHT treatment and an added sucrose fatty acid ester.

A cold coffee drink in accordance with JP11075693 is obtained by freezing a coffee concentrate with liquid cow's milk.

The main disadvantage of the above-mentioned techniques to prepare ice coffee is that the various ingredients must be mixed with supplementary additives. In addition, resealable recipients involve the risk of contamination.

The valuation of liquid coffee is expressed in brix, a sugar solution scale at a certain temperature and indicates how much of the liquid's mass-percent consists of sugar.

According to the “Tea & Coffee Trade Journal, Vol. 178/No. 5, 2006”, a pure liquid coffee extract with a brix of 23.5 is stable and has natural antimicrobial properties. in U.S. Pat. No. 3,119,695 a concentrate with 30 brix is stabilized.

### SUMMARY OF THE INVENTION

Surprisingly, we have discovered that the composition of our liquid coffee extract with additives, contained in a pressurized recipient and sprayed onto a liquid, results in a reliable and high-quality ice coffee.

This invention is therefore aimed at providing a solution for the above-mentioned disadvantages.

A pressurized recipient is filled with a liquid coffee extract to which at least one of the following additives such as aromas, sugars and/or sweeteners is added in proportion, and which can be adapted depending on the consumer's preferences.

Our invention has the following advantages. The consumer himself determines the portion he wishes to consume, without having to close the recipient again afterwards, involving the risk of contamination.

In addition, the liquid coffee extract with additives is composed in such a manner that it has a high antimicrobial and stabilizing effect.

Our invention does not require any additional mixing installations, since our pressurized dispenser sprays the composed extract onto a liquid surface, in the form of a jets creating a mixing effect. This has a second advantage.

Another advantage is that our preparation method for ice coffee, by using an appropriate holder and dispenser, results in a layer of foam on the ice coffee. The gases in the holder and dispenser keep the consumable contents free of contamination and ensure the fire safety. This has a last advantage.

### DETAILED DESCRIPTION OF THE INVENTION

The preparation of ice coffee in accordance with our invention consists of a holder and dispenser, which is pressurized and allows the contents to he sprayed onto a liquid, in the form of a jet.

The holder consists of a space or compartment, containing a liquid coffee extract, and a space or compartment with a pressure medium. In certain embodiments both compartments are uniformly connected. The holder is fitted with a nozzle and a valve to separate the compartment with the extract and the nozzle.

The composition of the liquid coffee extract consists of an amount of liquid coffee concentrate, to which at least one additive such as sugars, artificial sweeteners and aromas is added. The composition can be a combination of the foregoing, or a specific selection.

In certain embodiments, flavorings for use in the composition include, without limitation, both natural and artificial flavor compounds. Preferred flavors are preferably flavors that are neither sweet nor sour. Preferred flavors for use are, again without limitation, tea, rose hips, honey, royal jelly, fruit extracts, vitamins, coffee, mint, spices such as ginger, pepper extract, exotic fruits, exotic vegetables, international, and ethnic flavors.

The composition of the present invention may contain sugar such as sucrose, glucose, fructose, xylose, high-fructose corn syrup and sugar alcohol, milk constituent, antioxidant, pH regulator, emulsifier and flavor as desired. Examples of the milk constituent include raw milk, whole milk, powdered whole milk, skimmed milk powder, dairy cream, concentrated milk, skimmed milk, partially skimmed milk and condensed milk. The coffee composition of the present invention preferably has a pH from 3 to 7.5, more preferably from 4 to 7, even more preferably from 5 to 7 from the viewpoint of the stability of the composition.

In certain embodiments, the composition can include cocoa. The cocoa used in the agglomerated particles of the present invention can be natural or “Dutched” chocolate or washed or fermented cocoa, from which a substantial portion of the fat or cocoa butter has been expressed or removed by solvent extraction, by pressing, or by other means. In certain embodiments, cocoa and or cocoa non-conched powder suitable for use in the present invention can contain from about 0.5% to about 30% fatty constituents. Dutched chocolate is prepared by treating cocoa nibs with alkaline material such as potassium carbonate in a manner well known in the art. Generally, it tends to have a darker color and also can be more flavorful than natural cocoas. Fermented cocoa powder can also be used in the present invention. This cocoa is prepared by fermenting green cocoa beans before roasting and milling. The fermentation is usually conducted by soaking the green beans in water for a week and then drying. Chocolate can be used as the cocoa source in the present invention and it is intended, therefore, that chocolate, as described above, be encompassed by the term “cocoa.”

The flavorings other than cocoa and instant coffee useful in making the agglomerated particles of the present invention include any one of the commercially available non-coffee flavors. Preferably, such flavors are sourced from encapsulated or liquid flavors. These non-coffee flavors can be natural or artificial in origin. Preferred non-coffee flavors include almond nut, amaretto, anisette, brandy, cappuccino, mint, cinnamon, cinnamon almond, cremè de menthe, grand mariner, peppermint stick, pistachio, Sambuca, apple, chamomile, cinnamon spice, crème, crème de menthe, vanilla, French vanilla, Irish crème, Kahlua, lemon, macadamia nut, orange, orange leaf, peach, strawberry, grape, raspberry, cherry, coffee, chocolate and the like, aroma enhancers such as acetaldehyde, herbs, spices, as well as mixtures of these flavors.

The flavoring agents are generally used in the compositions at levels of from about 0.001% to about 25%, by weight of the composition. Preferably, the flavor is present from about 0.01% to about 15%, more preferably from about 0.05% to about 10%, and most preferably from about 0.1% to about 5%. The flavor can be present as the entire flavor composition or can be combined with other selected flavor ingredients. Preferred flavor agents for use in the compositions include those derived from Mentha species such as M. piperita (peppermint), M. arvensis (corn mint), M. spicata (U.S. native spearmint), M. cardiaca (Scotch spearmint) and M. viridis Crispa (spearmint form China).

The flavor agents may comprise additional flavor ingredients including, but not limited to, oil of wintergreen, clove bud oil, cassia, sage, parsley oil, marjoram, lemon, orange, cis-jasmone, 2,5-dimethyl-4-hydroxy-3(2H)-furanone, 5-ethyl-3-hydroxy-4-methyl-2(5H)-furanone, vanillin, ethyl vanillin, anisaldehyde, 3,4-methylenedioxybenzaldehyde, 3,4-dimethoxybenzaldehyde, 4-hyroxydroxybenzaldehyde, 2-methoxybenzaldehyde, benzaldehyde; cinnamaldehyde, hexyl cinnamaldehyde, alpha-methyl cinnamaldehyde, ortho-methoxy cinnamaldehyde, alpha-amyl cinnamaldehydepropenyl guaethol, heliotropine, 4-cis-heptenal, diacetyl, methyl-p-tert-butyl phenyl acetate, menthol, methyl salicylate, ethyl salicylate, 1-menthyl acetate, oxanone, alpha-irisone, methyl cinnamate, ethyl cinnamate, butyl cinnamate, ethyl butyrate, ethyl acetate, methyl anthranilate, iso-amyl acetate, iso-amyl butyrate, allyl caproate, eugenol, eucalyptol, thymol, cinnamic alcohol, octanol, octanal, decanol, decanal, phenylethyl alcohol, benzyl alcohol, alpha-terpineol, linalool, limonene, citral, maltol, ethyl maltol, anethole, dihydroanethole, carvone, menthone, .beta.-damascenone, ionone, gamma decalactone, gamma nonalactone, and gamma undecalaetone and mixtures thereof.

The flavor ingredients may be provided as single or purified chemicals or supplied in the composition by addition of natural oils or extracts that have preferably undergone the present water-washing treatment or other refining to remove components that are relatively unstable and may degrade aid alter the desired flavor profile, resulting in a less acceptable product from an organoleptic standpoint.

The flavor agent may also include cis-jasmone; 2,5-dimethyl-4-hydroxy-3(2H)-furanone; 5-ethyl-3-hydroxy-4-methyl-2(5H)-furanone; vanillin; ethyl vanillin; anisaldehyde; 3,4-methylenedioxybenzaldehyde; 3,4-dimethoxybenzaldehyde; 4-hydroxybenzaldehyde; 2-methyoxybenzaldehyde; 4-methoxybenzaldehyde; benzaldehyde; cinnamaldehyde; hexyl cinnamaldehyde; alpha-methyl cinnamaldehyde; ortho-methoxy cinnamaldehyde; alpha-amyl cinnamaldehyde; and combinations thereof. Many of these protectants are flavor ingredients.

The flavor agents may further comprise cooling agents or coolants such as menthol, menthyl esters, carboxamides, ketals, diols, and mixtures thereof. Examples of suitable coolants useful in the present compositions are the paramenthan carboxamide agents such as N-ethyl-p-menthan-3-carboxamide, known commercially as “WS-3”; N,2,3-trimethyl-2-isopropylbutanamide, known as “WS-23”; N-.rho.-benzeneacetonitrile-menthanecarboxamide; and others in the series such as WS-5, WS-11, WS-14 and WS-30. Additional suitable coolants include 3-1-menthoxypropane-1,2-diol known as TK-10 manufactured by Takasago; menthone glycerol acetal (Frescolat MGA); menthyl esters such as menthyl acetate, menthyl acetoacetate, menthyl lactate (Frescolat ML supplied by Haarmann and Reimer), and monomenthyl succinate (under the tradename Physcool from V. Mane), The terms menthol and menthyl as used herein include dextro- and levorotatory isomers of these compounds and racemic mixtures thereof. TK-10 is described in U.S. Pat. No. 4,459,425, Amano et al., issued Jul. 10, 1984. WS-3 and other agents are described in U.S. Pat. No. 4,136,163, Watson, et al., issued Jan. 23, 1979.

The flavor agents may include a sweetening agent. Suitable sweeteners include those well known in the art, including both natural and. artificial sweeteners. Some suitable water-soluble sweeteners include monosaccharides, disaccharides, polysaccharides and derivatives such as xylose, ribose, glucose (dextrose), mannose, galactose, fructose (levulose), sucrose (sugar), maltose, invert sugar (a mixture of fructose and glucose derived from sucrose), partially hydrolyzed starch, corn syrup solids, dihydrochalcones, monellin, steviosides, glycyrrhizin, xylitol and erythritol. Suitable water-soluble artificial sweeteners include soluble saccharin salts, i.e., sodium or calcium saccharin salts, cyclamate salts, the sodium, ammonium or calcium salt of 3,4-dihydro-6-methyl-1,2,3-oxathiazine-4-one-2,2-dioxide, the potassium salt of 3,4-dihydro-6-methyl-2,3-oxathiazine-4-one-2,2-dioxide (acesulfame-K), the free acid form of saccharin, and the like. Other suitable sweeteners include dipeptide based sweeteners, such as L-aspartic acid derived sweeteners, such as L-aspartyl-L-phenylalanine methyl ester (aspartame) and materials described in U.S. Pat. No. 3,492,131, L-alpha-aspartyl-N-(2,2,4,4-tetramethyl-3-thietanyl)-D-alaninamide hydrate, methyl esters of L-aspartyl-L-phenylglycerin and L-aspartyl-L-2,5,dihydrophenyl-glycine, L-aspartyl-2,5-dihydro-L-phenylalanine, L-aspartyl-L-(1-cyclohexyen)-alanine, and the like. Water-soluble sweeteners derived from naturally occurring water-soluble sweeteners, such as a chlorinated derivative of ordinary sugar (sucrose), known, for example, under the product description of sucralose as well as protein based sweeteners such as thaumatococus danielli (Thaumatin I and II) can he used. The composition preferably contains from about 0.1% to about 10% of sweetener, preferably from about 0.1% to about 1%, by weight.

In addition the flavor agents may include salivating agents, warming agents, and numbing agents. These agents are present in the compositions at a level of from about 0.001% to about 10%, preferably from about 0.1% to about 1%, by weight of the composition. Suitable salivating agents include Jambu manufactured by Takasago. Examples of warming agents are capsicum and nicotinate esters, such as benzyl nicotinate. Suitable numbing agents include benzocaine, lidocaine, clove bud oil, and ethanol.

Suitable creamers for use in the agglomerated particles of the present invention include dairy creamers, non-dairy creamers, synthetic and imitation dairy products, non-fat and whole milk solids. The creamer can be made from a variety of fats and oils including soybean and partially hydrogenated soybean oil, partially hydrogenated canola oil, hydrogenated and partially hydrogenated coconut oil, as well as other hydrogenated vegetable oils, or combinations of such oils. In other embodiments, the creamer can also include non-hydrogenated vegetable oil, coconut oil, canola oil, and other non-hydrogenated oils. Preferred creamers include non-dairy creamers made from vegetable oils, emulsifier, carbohydrates, sodium casemate, and buffers. Additional creamers suitable for use in the present invention include those synthetic and imitation dairy products disclosed in KIRK OTHMER ENCYCLOPEDIA OF CHEMICAL TECHNOLOGY, W. J. Harper, Willey Interscience, 3rd edition, Vol. 22, section entitled “Synthetic and Imitation Dairy Products,” pp. 465-498, (1978).

Sugars are mainly understood to mean, without any limitation, monosaccharides and disaccharides such as dextrose, fructose, glucose, saccharose (sucrose), maltose, etc. The artificial sweeteners mainly concern acesulfame K, sucralose, saccharine, aspartame, mannitol, sorbitol, xylitol, etc.

In addition, various aromas, both natural and artificial, can be added such as vanilla, nuts, alcohol-free flavoring such as rum, Irish cream, Amaretto, Whisky, Cognac, as well as cream, milk aroma, and the like.

In addition natural nutritional sweeteners tor example, Luo Han Guo and Advantaam can be included in the invention.

In addition, the invention can also be utilized using teas in addition to or instead of coffee. In various embodiments, teas include, but axe not limited to white teas: wilted and unoxidized; yellow teas: unwilted and unoxidized, but allowed to yellow; green teas: unwilted and unoxidized; oolong teas : wilted, braised, and partially oxidized; black teas: wilted, sometimes crushed, and fully oxidized (called ‘red tea’ in China); and post-Fermented: green tea that has been allowed to ferment/compost (‘black tea’ for the Chinese).

In other embodiments, the invention can also include dressings or sauces.

It is clear that the above-mentioned list of additives is not exhaustive and that other combinations are possible as well.

In addition, the additives can be added to the composition in a variety of forms, for example liquid, viscous, powdered, gel, or the like.

The proportion between the additives is such that the consumer can choose the composition which meets his preferences.

The holder has a space with a pressure medium. This pressure medium preferably is a propellant, such as nitrogen (N₂) and/or other gases. This pressure medium will dispense the product, mixed with additives, from the holder, through other space and through the nozzle.

Below are several possible compositions, but this list is not exhaustive. These examples ate only illustrative and cannot be considered as a limitation for the invention.

### EXAMPLE 1

Coffee concentrate 28 Brix: 450 g;

Sweeteners: 7 g;

Vanilla aroma: 4 g;

Nitrogen: 2.8 g.

### EXAMPLE 2

Coffee concentrate 40 Brix: 1000 g.

Sweeteners: 20 g.

Vanilla aroma: 12 g.

Amaretto aroma: 55 g.

Nitrogen: 8 g.

### EXAMPLE 3

Coffee concentrate 40 Brix: 1000 g.

Sucralose: 8 g.

Acesulfame K: 10 g.

Vanilla aroma: 10 g.

Nitrogen: 9 g.

As regards the proportion, we suggest the following ratio:
a. Coffee concentrate: 80-90%
b. Artificial sweeteners: 0-2%
c. Sugars (mono- and disaccharides): 0-20%
d. Aromatic additives: 0-10%
e. Propellant (nitrogen and/or nitrous oxide): 0.1-2%

The Brix value of the liquid coffee extract is preferably between 20 and 70.

In accordance with a possible embodiment, the bolder is turned upside down, with the nozzle facing downwards, so that the product can be dispensed through the nozzle. A jet of liquid coffee extract with additives is then sprayed onto a liquid, through the nozzle. This liquid could be milk.

According to another possible embodiment, the holder is fitted in a dispensing device. This dispensing device allows the consumer to prepare ice coffee automatically. At least one holder is fitted in the dispensing device. In case of several holders with different composition, the consumer can choose his preferred holder.

This dispensing device can be fitted with a refrigerating device, to keep the holders sufficiently cool. Well-known refrigeration techniques such as, for example, pettier technology, convection, conduction, and heat exchange are eligible.

The dispensing device can also be fitted with an ice generator to dispense ground ice shavings while dispensing the extract.

### EXAMPLE 4

Test protocol: we have to define the difference in taste, color and delivery of the Coffee Concentrate, with a BRIX ratio of 40 and in application with Sucralose as sweetener, Vanilla, Melted and mixed Homogenized Chocolate as Mocha Mixture out of the Can; and this with the same volumes of Coffee Concentrate and the same volume of Liquid, in this case Water.

We fill 5 cans of the same recipe as above in the same style and size of Aluminum Cans with the same style Laminated Steel Valves and pressurized with the same pressure. The recipe is based on 1 liter of mix.

The outcome of this test will show the difference between the different pressures of Homogenization.

WEEK 1:—day 1 Coffee concentrate is packed in the Cans—day 2 start with the tests.

| Coffee | Concentrate | Chocolate | Homogenized | Temperature | Water | Look | Taste |
|---|---|---|---|---|---|---|---|
| BRIX 40 | 6 ml | 30 gr/Can | 40 bar | 20° C. | 160 ml | nice color | good |
| BRIX 40 | 6 ml | 30 gr/Can | 40 bar | 30° C. | 160 ml | nice color | good |
| BRIX 40 | 6 ml | 30 gr/Can | 40 bar | 40° C. | 160 ml | nice color | good |
| BRIX 40 | 6 ml | 30 gr/Can | 40 bar | 50° C. | 160 ml | nice color | good |
| BRIX 40 | 6 ml | 30 gr/Can | 40 bar | 60° C. | 160 ml | nice color | good |
| BRIX 40 | 6 ml | 30 gr/Can | 50 bar | 20° C. | 160 ml | nice color | good |
| BRIX 40 | 6 ml | 30 gr/Can | 50 bar | 30° C. | 160 ml | nice color | good |
| BRIX 40 | 6 ml | 30 gr/Can | 50 bar | 40° C. | 160 ml | nice color | good |
| BRIX 40 | 6 ml | 30 gr/Can | 50 bar | 50° C. | 160 ml | nice color | good |
| BRIX 40 | 6 ml | 30 gr/Can | 50 bar | 60° C. | 160 ml | nice color | good |
| BRIX 40 | 6 ml | 30 gr/Can | 70 bar | 20° C. | 160 ml | nice color | good |
| BRIX 40 | 6 ml | 30 gr/Can | 70 bar | 30° C. | 160 ml | nice color | good |
| BRIX 40 | 6 ml | 30 gr/Can | 70 bar | 40° C. | 160 ml | nice color | good |
| BRIX 40 | 6 ml | 30 gr/Can | 70 bar | 50° C. | 160 ml | nice color | good |
| BRIX 40 | 6 ml | 30 gr/Can | 70 bar | 60° C. | 160 ml | nice color | good |
| BRIX 40 | 6 ml | 30 gr/Can | 90 bar | 20° C. | 160 ml | nice color | good |
| BRIX 40 | 6 ml | 30 gr/Can | 90 bar | 30° C. | 160 ml | nice color | good |
| BRIX 40 | 6 ml | 30 gr/Can | 90 bar | 40° C. | 160 ml | nice color | good |
| BRIX 40 | 6 ml | 30 gr/Can | 90 bar | 50° C. | 160 ml | nice color | good |
| BRIX 40 | 6 ml | 30 gr/Can | 90 bar | 60° C. | 160 ml | nice color | good |
| BRIX 40 | 6 ml | 30 gr/Can | 110 bar | 20° C. | 160 ml | nice color | good |
| BRIX 40 | 6 ml | 30 gr/Can | 110 bar | 30° C. | 160 ml | nice color | good |
| BRIX 40 | 6 ml | 30 gr/Can | 110 bar | 40° C. | 160 ml | nice color | good |
| BRIX 40 | 6 ml | 30 gr/Can | 110 bar | 50° C. | 160 ml | nice color | good |
| BRIX 40 | 6 ml | 30 gr/Can | 110 bar | 60° C. | 160 ml | nice color | good |
| BRIX 40 | 6 ml | 30 gr/Can | 130 bar | 20° C. | 160 ml | nice color | good |
| BRIX 40 | 6 ml | 30 gr/Can | 130 bar | 30° C. | 160 ml | nice color | good |
| BRIX 40 | 6 ml | 30 gr/Can | 130 bar | 40° C. | 160 ml | nice color | good |
| BRIX 40 | 6 ml | 30 gr/Can | 130 bar | 50° C. | 160 ml | nice color | good |
| BRIX 40 | 6 ml | 30 gr/Can | 130 bar | 60° C. | 160 ml | nice color | good |
| BRIX 40 | 6 ml | 30 gr/Can | 150 bar | 20° C. | 160 ml | nice color | good |
| BRIX 40 | 6 ml | 30 gr/Can | 150 bar | 30° C. | 160 ml | nice color | good |
| BRIX 40 | 6 ml | 30 gr/Can | 150 bar | 40° C. | 160 ml | nice color | good |
| BRIX 40 | 6 ml | 30 gr/Can | 150 bar | 50° C. | 160 ml | nice color | good |
| BRIX 40 | 6 ml | 30 gr/Can | 150 bar | 60° C. | 160 ml | nice color | good |

The results from this test are important for the thickness of the recipe. The taste of all products were good. When drying recipes with pressures above the 70 bar some amount of serum came out of the emulsion but after mixing or shaking the emulsion became again stable.

Homogenization gives a positive reaction on the emulsion and could avoid thickening of the emulsion in the time.

### EXAMPLE 5

Test protocol: we have to define the difference in taste, color and delivery of the Coffee Concentrate, with a BRIX ratio of 40 and in application with Sucralose as sweetener, out of the Can; and this with, the same volumes of Coffee Concentrate and the same volume of Liquid, in this case Water.

We fill 5 cans of each Concentrate (BRIX value 40)÷Sucralose (different weight) in the same style and size of Aluminum Cans with the same style Laminated Steel Valves and pressurized with the same pressure. The recipe is based on 1 liter of mix.

We will do the same tests with adding Vanilla: Test 2, with Vanilla and Caramel Test 3, with Vanilla and Chocolate (Mocha) Test 4. The Vanilla and the Caramel are concentrates from Vanilla and from Caramel. For the Chocolate we used concentrate, Chocolate Syrup and real Chocolate. The real Chocolate is in the range of 15% up to 82% of Cocoa Solids.

Some tests were done with Chocolate without refiner conches. In this case the Chocolate is grinded into powder and has a stronger taste. Unfortunate the taste is not as soft as with the refined conches Chocolate.

WEEK 1:—day 1 Coffee concentrate is packed in the Cans—day 2 start with the tests

| Coffee | Concentrate | Sucralose | Water | Look | Taste |
|---|---|---|---|---|---|
| BRIX 40 | 6 ml | 0.5 gr | 160 ml | nice color | no sweet |
| BRIX 40 | 6 ml | 0.75 gr | 160 ml | nice Color | little sweet |
| BRIX 40 | 6 ml | 1 gr | 160 ml | nice color | little sweet |
| BRIX 40 | 6 ml | 1.1 gr | 160 ml | nice color | not sweet |
| | | | | | enough |
| BRIX 40 | 6 ml | 1.15 gr | 160 ml | nice color | not sweet |
| | | | | | enough |
| BRIX 40 | 6 ml | 1.20 gr | 160 ml | nice color | not sweet |
| | | | | | enough |
| BRIX 40 | 6 ml | 1.25 gr | 160 ml | nice color | not sweet |
| | | | | | enough |
| BR1X 40 | 6 ml | 1.30 gr | 160 ml | nice color | little sweet |
| | | | | | taste |
| BRIX 40 | 6 ml | 1.35 gr | 160 ml | nice color | little sweet |
| | | | | | taste |
| BRIX 40 | 6 ml | 1.40 gr | 160 ml | nice color | nearly sweet |
| | | | | | enough |
| BRIX 40 | 6 ml | 1.45 gr | 160 ml | nice color | nearly sweet |
| | | | | | enough |
| BRIX 40 | 6 ml | 1.50 gr | 160 ml | nice color | nearly sweet |
| | | | | | taste |
| BRIX 40 | 6 ml | 1.55 gr | 160 ml | nice color | nice sweet |
| | | | | | taste |
| BRIX 40 | 6 ml | 1.60 gr | 160 ml | nice color | sweet taste |
| BRIX 40 | 6 ml | 1.65 gr | 160 ml | nice color | strong sweet |
| | | | | | taste |
| BRIX 40 | 6 ml | 1.70 gr | 160 ml | nice color | too strong |
| taste | | | | | sweet |

### WEEK 4: Test with the same Cans

1.30 gr: same results as week 1

1.35 gr: same results as week 1

1.40 gr: same results as week 1

1.45 gr: same results as week 1

1.50 gr: same results as week 1

1.55 gr: same results as week 1

1.60 gr: same results as week 1

1.65 gr: same results as week 1

1.70 gr: same results as week 1

### WEEK 8: Test with the same Cans

Same results as week 1 except for 1.45+1.50+1.55+1.60 decrease of sweet

### WEEK 16: Test with the same Cans

Same results as week 1 except for 1.45+1.50+1.55+1.60 decrease of sweet _

### WEEK 24: Test with the same Cans

Same results as week 1 except for 1.45+1.50+1.55+1.60+1.65+1.70 decrease of sweet

### EXAMPLE 6—WITH VANILLA

Same volume and weight of Coffee Concentrate and Sucralose.

We add on the recipe 8 gr Vanilla/Liter

Day 2: good taste, soft Vanilla taste

Week 4: good taste, soft Vanilla taste

Week 8: good taste, soft Vanilla taste

Week 16: good taste soft Vanilla taste

Week 24: good taste soft Vanilla taste and a little more sweet taste than the one without Vanilla

10 gr Vanilla/Liter

Day 2: good taste, good Vanilla taste

Week 4: good taste, good Vanilla taste

Week 8: good taste, good Vanilla taste

Week 16: good taste good Vanilla taste

Week 24: good taste, good Vanilla taste and increase of the sweet taste

12 gr Vanilla/Liter

Day 2: very good taste, good Vanilla taste

Week 4: very good taste, good Vanilla taste

Week 8: very good taste, good Vanilla taste

Week 16: very good taste, good Vanilla taste

Week 24: very good taste, good Vanilla taste and increase of the sweet taste

14 gr Vanilla/Liter

Day 2: too strong Vanilla taste

Week 4: too strong Vanilla taste

Week 8: too strong Vanilla taste

Week 16: too strong Vanilla taste

Week 24: too strong Vanilla taste and increase of the sweet taste

This results in the stability of the sweet taste. The 12 gram vanilla is the best combination.

Without the addition of Vanilla the sweet taste of the Sucralose decreases; however, with the addition of vanilla the sweet taste increases. The combination of vanilla and sucralose maintains the sweet taste and is stable and consistent over a period of 24 weeks.

### EXAMPLE 7

We add Caramel Flavor Boosted with Natural Vanilla at the recipe

100 gr/Liter Caramel to the recipe+Sucralose 1.5 gr+Vanilla 12 gr

Day 2: little Caramel tastes good Vanilla taste

Week 4: little Caramel taste, good Vanilla taste

Week 8: little Caramel taste, good Vanilla taste

Week 16: little Caramel taste, good Vanilla taste

Week 24: Good Vanilla taste and little Caramel Taste

150 gr/Liter Caramel to the recipe+Sucralose 1.5 gr+Vanilla 12 gr

Day 2: good Caramel taste, good Vanilla taste

Week 4: good Caramel taste, good Vanilla taste

Week 8: good Caramel taste, good Vanilla taste

Week 16: good Caramel taste, good Vanilla taste

Week 24: good Vanilla taste and good Caramel Taste

200 gr/Liter Caramel to the recipe+Sucralose 1.5 gr+Vanilla 12 gr

Day 2: very good Caramel taste, good Vanilla taste

Week 4: very good Caramel taste, good Vanilla taste

Week 8: very good Caramel taste, good Vanilla taste

Week 16: very good Caramel taste, good Vanilla taste

Week 24: good Vanilla taste and very good Caramel Taste

This means 20% of the product volume in the can is Caramel Flavor boosted with Natural Vanilla.

### EXAMPLE 8

We added melted hot Chocolate to the recipe Brix 40, 1.5 gr Sucralose, 12 gr Vanilla

30 gr/Can Chocolate 53% to the recipe+Sucralose 1.5 gr+Vanilla 12 gr

Day 2: moderate Chocolate/Vanilla taste

Week 4: moderate Chocolate/Vanilla taste

Week 8: moderate Chocolate/Vanilla taste

Week 16: moderate Chocolate/Vanilla taste

Week 24: moderate Chocolate/Vanilla taste

40 gr/Can Chocolate 53% to the recipe+Sucralose 1.5 gr+Vanilla 12 gr

Day 2: good Chocolate/Vanilla taste

Week 4: good Chocolate/Vanilla taste

Week 8: good Chocolate/Vanilla taste

Week 16: good Chocolate/Vanilla taste

Week 24: good Chocolate/Vanilla taste

50 gr/Can Chocolate 53% to the recipe+Sucralose 1.5 gr+Vanilla 12 gr

Day 2: very good Chocolate/Vanilla taste

Week 4: very good Chocolate/Vanilla taste

Week 8: very good Chocolate/Vanilla taste

Week 16: very good Chocolate/Vanilla taste

Week 24: very good Chocolate/Vanilla taste

We tested also the different range of 20% up to 85% of Chocolate, this resulted that the combination with the range 53%-82% cocoa solids was the best combination.

Tests with unrefined (not been conched) Cocoa Solids 22%-90% are similar as the different test with the Conched Cocoa. This would give the following advantage: the solid material will mix with the Coffee Concentrate it will nearly not separate or it will not easily thicken.

Hereafter the different percentages.

50 gr of 30% unrefined Cocoa Solids to the receipt Sucralose 1.5 gr+Vanilla 12 gr

Day 2: moderate Chocolate/Vanilla taste

Week 4: moderate Chocolate/Vanilla taste

Week 8: moderate Chocolate/Vanilla taste

Week 16: moderate Chocolate/Vanilla taste

Week 24: moderate Chocolate/Vanilla taste

50 gr of 50% unrefined Cocoa Solids to the receipt Sucralose 1.5 gr+Vanilla 12 gr

Day 2: good Chocolate/Vanilla taste

Week 4: good Chocolate/Vanilla taste

Week 8: good Chocolate/Vanilla taste

Week 16: good Chocolate/Vanilla taste

Week 24: good Chocolate/Vanilla taste

50 gr of 60% unrefined Cocoa Solids to the receipt Sucralose 1.5 gr+Vanilla 12 gr

Day 2: very good Chocolate/Vanilla taste

Week 4: very good Chocolate/Vanilla taste

Week 8: very good Chocolate/Vanilla taste

Week 16: very good Chocolate/Vanilla taste

Week 24: very good Chocolate/Vanilla taste

50 gr of 80% unrefined Cocoa Solids to the receipt Sucralose 1.5 gr+Vanilla 12 gr

Day 2: too strong Chocolate

Week 4: too strong Chocolate

Week 8: too strong Chocolate

Week 16: too strong Chocolate

Week 24: too strong Chocolate

The best recipe combination is:

Vanilla

Vanilla 12 gr+Sucralose 1.5 gr

Caramel: 20% Caramel+Sucralose 1.5 gr+Vanilla 12 gr

Chocolate: between 20 and 50 gr Chocolate at 60% of unrefined (not conched)

Cocoa Solids, because it will not thicken as quickly as the Chocolate

Version or between 20 and 60 gr of Chocolate at 53% of refined version.

The values disclosed herein are not to be understood as being strictly limited to the exact numerical values recited. Instead, unless otherwise specified, each such value is intended to mean both the recited value and a functionally equivalent range surrounding that value. For example, a value disclosed as “40” is intended to mean “about 40.”

All documents herein are, in relevant part, incorporated herein by reference; the citation of any document is not to be construed as an admission that it is prior art with respect to the present invention. To the extent that any meaning or definition of a term in this written document conflicts with any meaning or definition of the term, in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims ail such changes and modifications that are within the scope of this invention.

The invention claimed is:

1. A dispensing device for dispensing coffee or a coffee extract comprising: a housing comprising:
i. a first compartment comprising a pressure medium;
ii. a second compartment comprising coffee or coffee extract;
iii. a nozzle in communication with the second compartment; and
iv. a valve situated between the nozzle and the second compartment; wherein the pressure medium in the first compartment is capable of expelling the coffee or coffee extract from, the second compartment; and
wherein, the coffee or coffee extract is located in the second compartment.

2. The dispensing device of claim 1, wherein the second compartment further comprises sugar, a sweetener, an aromatic additive, or a combination thereof.

3. The dispensing device of claim 2, wherein the sugar is dextrose, fructose, glucose, saccharose (sucrose) or maltose.

4. The dispensing device of claim 2, wherein the sweetener is acesulfame K, sucralose, saccharine, aspartame, mannitol, sorbitol, or xylitol.

5. The dispensing device of claim 2, wherein the aromatic additive comprises both natural and artificial aromatic additives comprising vanilla, nuts, alcohol-free flavoring, or milk aroma.

6. The dispensing device of claim 1, wherein the second compartment further comprises about 80-90% coffee concentrate, about 0-2% sweeteners, about 0-20% mono- and disaccharides, and about 0-10% aromatic additives; and the first compartment comprises about 0.1-2% propellant.

7. The dispensing device of claim 1, wherein the coffee or coffee extract is used for making iced coffee.

8. A dispensing device for dispensing a coffee drink comprising:
a. a housing comprising:
i. a first compartment comprising a pressure medium;
ii. a second compartment comprising coffee or coffee extract, vanilla, and sucralose;
iii. a nozzle in communication with the second compartment; and
iv. a valve situated between the nozzle and the second compartment;
wherein the pressure medium in the first compartment is capable of expelling the coffee or coffee extract from the second compartment; and
wherein the coffee or coffee extract, vanilla, and sucralose is located in the second compartment; and wherein the combination of vanilla and sucralose imparts a consistent flavor to coffee drink over a period of about 24 months.

9. The dispensing device of claim 8, wherein the second compartment further comprises sugar, an aromatic additive, or a combination thereof.

10. The dispensing device of claim 9, wherein the sugar is dextrose, fructose, glucose, saccharose (sucrose) or maltose.

11. The dispensing device of claim 9, wherein the aromatic additive comprises both natural and artificial aromatic additives comprising vanilla, nuts, alcohol-free flavoring, or milk aroma.

12. The dispensing device of claim 8, wherein the second compartment further comprises about 80-90% coffee concentrate, about 0-20% mono- and disaccharides, and about 0-10% aromatic additives; and the first compartment comprises about 0.1-2% propellant.

13. The dispensing device of claim 1, wherein the coffee drink is used for making iced coffee.
